(19) United States
(12) Patent Application Publication
(10) Pub. No.: US 2005/0242147 A1
(43) Pub. Date: Nov. 3, 2005

(54) Mechanism for disassembling and dispensing pre-cut packaging material

(76) Inventors: Michael William Tobin, Bozeman, MT (US); David William Roecker, Denver, CO (US); Karl M. Armagost, The Villages, FL (US)

Correspondence Address: SHOOK, HARDY & BACON LLP, 2555 GRAND BLVD, KANSAS CITY,, MO, 64108, US

(21) Appl. No.: 10/993,179

(22) Filed: Nov. 19, 2004

Related U.S. Application Data
(60) Provisional application No. 60/523,445, filed on Nov. 19, 2003.

(51) Int. Cl. B26F 3/00

(52) U.S. Cl. 225/97

(57) ABSTRACT

This disassembly of a pre-cut block of packaging material into component pieces and the selective dispensing of the component pieces is accomplished by a mechanism including a disassembling apparatus and a dispensing apparatus surrounded by a housing. The disassembling apparatus accepts individual pre-cut blocks from a queue and compresses a portion of the respective pre-cut block to cause separation into the plurality of component pieces. The plurality of component pieces then fall into the dispensing apparatus, which selectively dispenses the pieces separated as desired by a user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Expanded polystyrene (EPS or EPS foam) is a material widely used in the packaging and shipping industry. More specifically, EPS and similar materials are placed in a shipping box or container around an item to provide cushioning and restrict movement of the item during transportation. When a unitary block of EPS is used, the block must be generally shaped to match the outlining shape of the items being shipped and the container into which the block and item are to be placed. Thus, a different block or sub-components thereof must be created for each type of item a manufacturer, distributor, or other entity is shipping. Although these blocks provide the best configuration to secure certain types of items within a container, it is often cost prohibitive for an entity to use blocks when they have many types of items to ship, each of which have a different size and shape. It is often preferred instead to use a plurality of smaller pieces of EPS, commonly referred to as “peanuts”, as packaging filler. These EPS pieces—which may take on the shape of a peanut or other geometric configurations—are loosely placed in a container with the item to be shipped. The EPS pieces take up the free space in the container around the item regardless of the item's shape. Some air gaps are usually found between adjacent EPS pieces, but these gaps usually are not enough to allow large movement of the item within the container once the container is sealed.

One problem with the use of EPS pieces, however, is storage. According to conventional processes, EPS pieces are typically manufactured at a central location, loaded into bags or other containers, and shipped to the location where they will be used as packaging material (e.g., at a manufacturing or distribution site for various items, such as consumer products, electronic equipment, etc.). During transportation and storage until use, EPS pieces take up a large amount of bulk space. Unfortunately, in many facilities and transportation vehicles, maintaining such storage space is quite expensive, and the space is better utilized when filled with items that bring a monetary return instead of packaging material.

To meet this need, it has been proposed to pre-cut blocks of EPS into a profile that resembles a plurality of small EPS pieces. These blocks are cut in such as way that the individual EPS pieces are not disassembled from the block initially, but only upon application of an input force applied to the block. This allows the pre-cut EPS block to be manufactured and shipped to the user in a compact shape, and when needed to serve as bulk material for packaging, the block may be disassembled. One particular example of a pre-cut EPS block, and methods of manufacturing thereof, is taught in both U.S. Pat. Nos. 5,947,293 and 5,992,633, both issued to Edgar Burchard, and entitled “Process For Cutting And Packaging Blocks Of Expanded Polystyrene Foam As A Loose Fill Cushioning Material”, the teachings of which are incorporated herein by reference. The EPS block is cut in a series of vertical slices perpendicular to one another, and in a series of sinusoidal or “wave” cuts to form the block into a plurality of “noodle” shaped pieces while maintaining the original geometric form of the block. In order to move the now pre-cut EPS block without disassembly into the noodle pieces, a plastic wrap or other material is placed around the block. This wrap may completely envelop the pre-cut EPS block in the form of a bag or the like, or preferably, extends tightly around the perimeter of the block covering its vertical sidewalls.

Still, there has been no reliable solution for how to easily and efficiently disassemble the pre-cut EPS blocks into individual noodle pieces when needed to serve as packaging filler. For example, a user could grab opposite sides of a block that has wrapped vertical sidewalls and pull outwardly on the lower portions thereof to deflect the block lower surface in a convex fashion and the block upper surface in a concave fashion. This causes distortion of the pre-cut EPS block and lateral separation between adjacent noodle pieces so that pieces no longer form a nesting geometric relationship with one another, and fall by the force of gravity away from the remainder of the block until the block is completely disassembled into the constituent noodle pieces. However, it is difficult for a user to control scattering of the noodle pieces as the pieces fall away from the block, and block disassembly by hand is time consuming and labor intensive since each pre-cut block must be individually picked up, placed over the desired container to catch the noodle pieces, and then a force applied to cause block disassembly. If a large container is needed for shipping an item, the user may have to disassemble a large number of blocks to generate enough packing filler to securely support the item.

### BRIEF SUMMARY OF THE INVENTION

The present invention provides a mechanism for queuing pre-cut blocks of packaging material, disassembling individual blocks into a plurality of component pieces and dispensing the component pieces as desired. In one aspect, the mechanism includes a housing, means for guiding a plurality of pre-cut blocks of packaging material into a housing in a queue, and a disassembling apparatus and dispensing apparatus mounted at least substantially within the housing. The disassembling apparatus accepts individual pre-cut blocks from the queue and compresses a portion of the respective pre-cut block to cause separation into the plurality of component pieces. The plurality of component pieces then fall into the dispensing apparatus, which selectively dispenses the pieces separated as desired by a user.

In another aspect, the disassembling apparatus includes a support frame having opposed lateral portions, a pair of upper articulating driver linkages, and first and second breaker bars. The each linkage of the pair of upper articulating driver linkages is disposed adjacent to one of the lateral portions of the frame and operable to transmit an input force received from a handle attached thereto. The first and second breaker bars are mounted with the frame lateral portions and coupled with the pair of upper articulating driver linkages for rotation in response to the transmitted input force, wherein a portion of pre-cut block of packaging material positioned within a holding region of the disassembling apparatus between the first and second breaker bars is compressed by rotation of the first and second breaker bars into the holding region upon receiving the input force from the forward and rearward output driver bars to cause the pre-cut block of packaging material to separate into the plurality of component pieces.

The invention of another aspect includes the dispensing apparatus being formed as a hopper with a lower section including selectively rotatable depending doors. The opening of the depending doors is controlled with a set of control rods coupled with lower articulating driver linkages that may be actuated by an attached handle. When the doors move into an open position, a bottom opening of the hopper is exposed to allow the plurality of component pieces to fall out of the hopper. Conversely, in the closed position, the depending doors close off the hopper bottom opening to retaining the plurality of component pieces within the hopper.

### BRIEF DESCRIPTION OF THE SEVERAL VIEWS OF THE DRAWING

In the accompanying drawings which form a part of the specification and are to be read in conjunction therewith and in which like reference numerals are used to indicate like elements in the various views:

FIG. 1 is a perspective view of a mechanism for disassembling a pre-cut block of packaging material into a plurality of component pieces and dispensing the component pieces in accordance with one embodiment of the present invention;

FIG. 2 is a perspective view of the mechanism of FIG. 1 with the housing partially cut-away to reveal the disassembling apparatus and the dispensing apparatus;

FIG. 3 is a fragmentary side elevational view with the housing partially cut-away to reveal the disassembling apparatus in a position to hold a pre-cut block of packaging material;

FIG. 4 is a fragmentary side elevational view of the disassembling apparatus in a position to compress a pre-cut block of packaging material to cause disassembly of the block;

FIG. 5 is a fragmentary top plan view of the disassembling apparatus shown holding a pre-cut block of packaging material;

FIG. 6 is a fragmentary side elevational view, partially in section, showing the disassembling apparatus holding a pre-cut block of packaging material;

FIG. 7 is another fragmentary side elevational view, partially in section, showing the disassembling apparatus having compressed a pre-cut block of packaging material and the resultant disassembly of the block into the component pieces;

FIG. 8 is a fragmentary front elevational view with the housing partially cut-away to reveal the dispensing apparatus having depending doors in a closed position;

FIG. 9 is another fragmentary front elevational view with the housing partially cut-away to reveal the dispensing apparatus having depending doors in an open position releasing an amount of component pieces;

FIG. 10 is a fragmentary side elevational view with the housing partially cut-away to reveal the dispensing apparatus having depending doors in a closed position; and

FIG. 11 is another fragmentary side elevational view with the housing partially cut-away to reveal the dispensing apparatus having depending doors in a closed position.

### DETAILED DESCRIPTION OF THE INVENTION

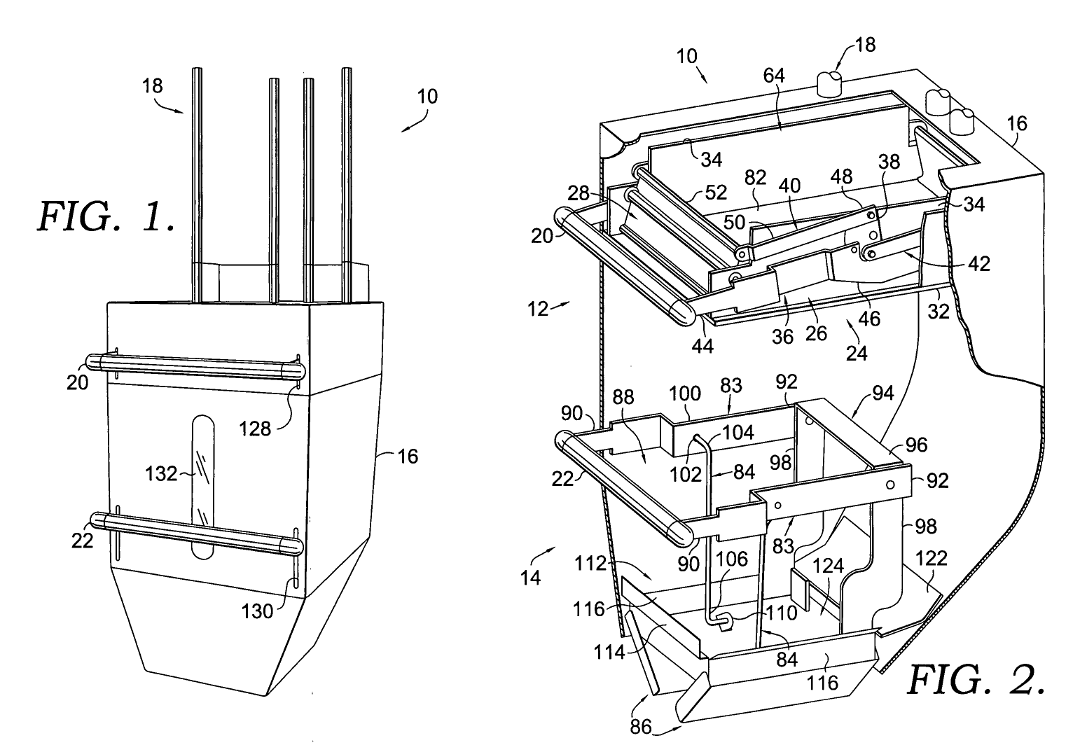

Turning now to the drawings, and in particular to FIGS. 1 and 2, there is shown generally a pre-cut EPS block disassembler and dispenser mechanism 10. The mechanism 10 includes a disassembling apparatus 12, a dispensing apparatus 14 and housing 16 substantially enclosing the disassembling apparatus 12 and the dispensing apparatus 14. A set of guide rails 18 extend from the housing 16 and serve to organize a stack of pre-cut EPS blocks (not shown) awaiting entry into the disassembling apparatus 12. More specifically, the guide rails 18 align a stack of pre-cut EPS blocks extending upward out of the housing 16 from the disassembling apparatus 12 in a queue. The housing 16 may be anchored to a rigid structure, such as a wall, or mounted onto a portable frame, if desired. As can also be seen, the disassembling apparatus 12 is actuated by the movement of an upper handle 20 upwardly and downwardly with respect to the housing 16, and the dispensing apparatus 14 is likewise actuated by the movement of a lower handle 22 upwardly and downwardly with respect to the housing 16, as will likewise be more fully explained below.

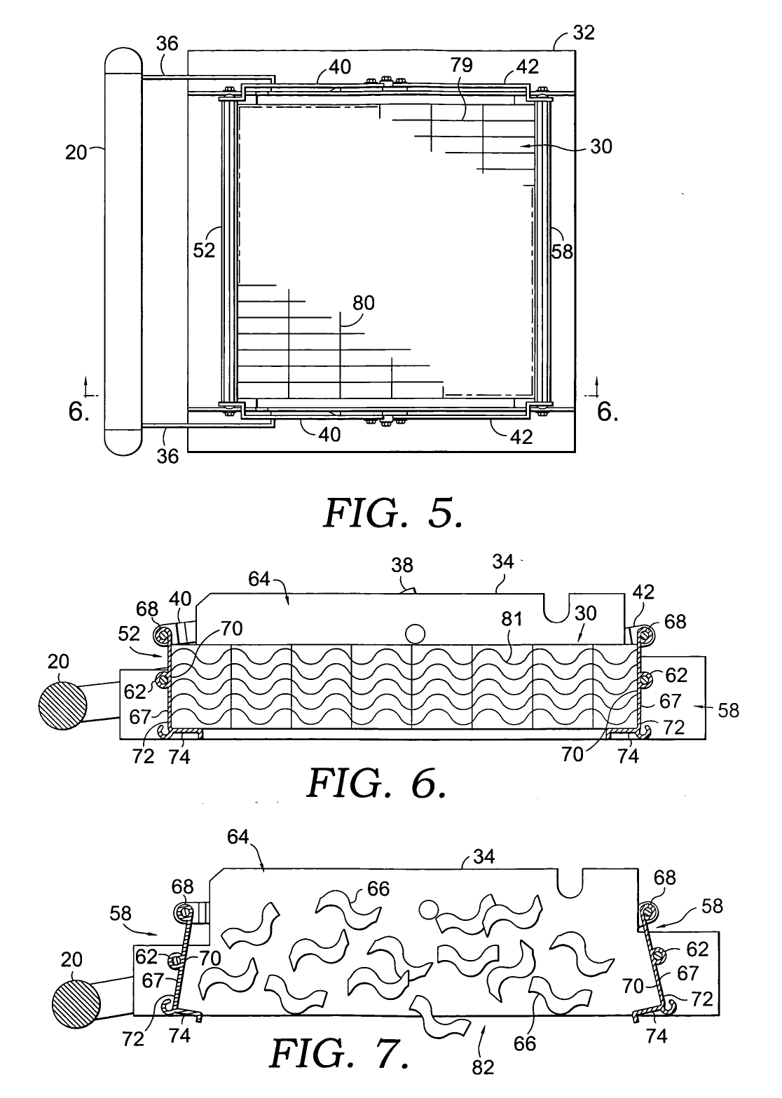

With particular reference to FIG. 2, the disassembling apparatus 12 is formed of a support frame 24 rigidly connected with the housing 16, a pair of upper articulating driver linkages 26 interconnected with one another by the upper handle 20 and operable to transmit an input force incident upon the upper handle 20, and a pair of opposed breaker bars 28 coupled with the upper driver linkages 26 and operable to rotate upon receiving the input force to compress a pre-cut EPS block 30 and cause disassembly of the block 30, as seen in FIGS. 5-7. The support frame 24 includes a perimeter base platform 32 and opposed lateral guide walls 34. Mounted to each of the lateral guide walls 34 is one of the pair of upper driver linkages 26, and spanning between and mounted with the lateral guide walls 34 are the opposed breaker bars 28. Each upper drive linkage 26 includes an input driver bar 36, and intermediate member in the form of a cam 38, a forward output driver bar 40 and a rearward output driver bar 42. The upper drive linkage 26 components, as well as the breaker bar 28 and the support frame 24, are preferably formed of a type of metal, plastic, composite or other suitably strong and dimensionally stable material, and may be fabricated through any number of methods that are well understood by those of skill in the art. For instance, the breaker bars 28 may be extruded to have a particular configuration that will be more fully explained below.

For the upper drive linkages 26, the input driver bars 36 have first ends 44 rigidly interconnected with one another by the upper handle 20, and each input bar 36 has a middle pivot connection 45 with one of the support frame guide walls 34 and a second end 46 connected through a slidable pivot with one of the cams 38, e.g., through a slot (not shown) in the cam 38. Each cam 38 is rotatably mounted with one of the support frame guide walls 34 at a pivot connection 60. Because both the input driver bar 36 and the cam 38 are pivotably connected with the support frame guide walls 34, the slotted connection between the cam 38 and the bar 36 enables the arcuate travel of both the cam 38 and the bar 36 while maintaining a connection there between through the slidable pivot.

Each forward output driver bar 40 of the upper drive linkages 26 has a first end 48 pivotably connected with the cam 38 and a second end 50 pivotably connected with a front breaker bar 52 of the pair of breaker bars 28. Similarly, the rearward output driver bar 42 has a first end 54 pivotably connected with the cam 38 and a second end 56 pivotably connected with a rear breaker bar 58 of the pair of breaker bars 28.

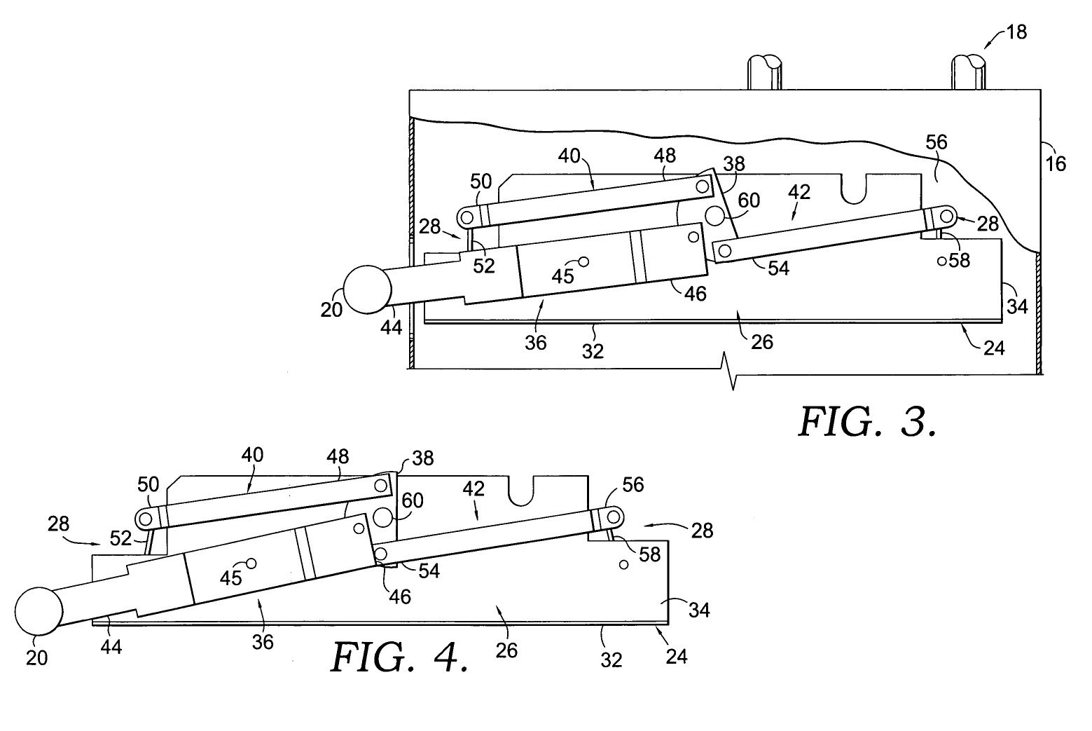

The pivot connection of the first end 48 of each forward output driver bar 40 with the respective cam 38 is generally on an opposite side of the cam pivot connection 60 from the pivot connection of the first end 54 of the rearward output driver bar 42 with the cam. Additionally, for each upper drive linkage 26, the slidable pivot connection of the second end 46 with the cam 38 is spaced from the pivot connections of the forward and rearward output driver bars, 40, 42 with the cam 38. It is this particular arrangement that facilitates the transferring of motion induced by downward movement of the upper handle 20 from each input driver bar 36, through the cam 38 and onto the forward and rearward output driver bars 40, 42, as can be seen in FIGS. 3 and 4, and in FIGS. 6 and 7. This motion transferred causes the front and rear breaker bars 52, 58 mounted on a rotational pivot axis 62 with the guide walls 34 to rotate about such pivot axis 62 and compress the pre-cut EPS block 30 positioned within a holding region 64 of the disassembling apparatus 12 bounded by the front and rear breaker bars 52, 58 and the guide walls 34. More specifically, the bounds of the holding region 64 may be determined when the front and rear breaker bars 52, 58 are in the standby position shown in FIG. 6. Rotation of a portion of the front and rear breaker bars 52, 58 into the holding region 64 compresses the block 30—which is somewhat dimensionally unstable, as will be more fully explained below—a sufficient amount as to cause disassembly of the block into a plurality of individual EPS component pieces 66, as shown in FIG. 7.

The front and rear breaker bars 52, 58, seen best in FIGS. 2, 6 and 7, each have a generally planar body 67 with an upper portion 68, a middle portion 70 where the rotational pivot axis 62 is located, and a lower portion 72, and a retaining flange 74 extending generally perpendicularly from the lower portion 72 of the planar body 67. A laterally extending top aperture 76 is formed in the upper portion 68 for accepting a fastener for the pivotable connection between the front and rear breaker bars 52, 58 and the forward and rearward output driver bars, 40, 42, respectively, of each upper drive linkages 26. A laterally extending middle aperture 78 is formed at the rotational pivot axis 62 for accepting a fastener for the rotatable mounting of the front and rear breaker bars 52, 58 with the guide walls 34.

As shown in FIGS. 5-7, the pre-cut EPS blocks 30 typically have a first dimensional cut line 79 extending vertically substantially or entirely through the block 30 in a forward to back alignment, a second dimensional cut line 80 extending vertically substantially or entirely through the block 30 in a lateral alignment perpendicular to first cut line 79, and a third dimensional cut line 81 extending in a sinusoidal cut pattern gradually moving horizontally through the block 30. A perimeter wrap (e.g. a stretch wrap band) extends around the block 30 keeps the component EPS pieces 66 together in the form of the block 30 despite the cuts until acted upon by the disassembling apparatus 12.

In use, the lowermost pre-cut EPS block 30 in a stack falls in the holding region 64, and the block 30 is directly supported by the retaining flanges 74 of the front and rear breaker bars 52, 58. Incidentally, the retaining flanges 74 also support the weight of other blocks 30 stacked on top of the single block 30 present in the holding region 64 in queue and guided by the guide rails 18. The user will push downwardly on the upper handle 20 with respect to the housing 16 to induce movement in both of the upper articulating driver linkages 26. Because the movement of each of the upper driver linkages 26 is a mirror image of the other, the movement of one of the linkages 26 will be described with reference to FIGS. 4, 6 and 7. However, it is understood that movement of both of the upper driver linkages 26 is taking place simultaneously.

With downward movement of the upper handle 20, the input driver bar 36 rotates about the middle pivot connection 45 and the slidable pivot connection between the second end 46 of the input driver bar and the cam 38 induces rotation of the cam 38 about the pivot connection 60. In turn, the cam 38 moves the forward and rearward output driver bars 40, 42 in such a way that the second end 50 of the forward output driver bar 40 distal to the cam 38 and the second end 56 of the rearward output driver bar 42 distal to the cam 38 move laterally inwardly towards the cam 38. Through the pivotable connection with the front and rear breaker bars 52, 58, the forward and rearward output driver bars 40, 42 induce rotation of the respective breaker bars 52, 58 about the pivot axis 62 thereof such that the upper portion 68 of the breaker bars 52, 58 moves inwardly towards the holding region 64 and the lower portion 72 of the breaker bars 52, 58 moves outwardly away from the holding region 64, as shown in FIG. 7.

With the rotation of the front and rear breaker bars 52, 58, the pre-cut EPS block 30 are placed in compression generally in upper regions thereof and in tension in lower regions thereof. The individual component EPS pieces 66, in a nesting geometry with one another, begin to move out of plane with one another and separation gaps form between the pieces 66. When there is insufficient friction between adjacent EPS pieces 66 to overcome the weight thereof, the EPS block will then substantially or completely disassemble into free EPS component pieces 66. At this point, the EPS pieces 66 will free fall under their own weight through an opening 82 in the perimeter base platform 32 of the support frame 24 into the dispensing apparatus 14. The next EPS block 30 in the stack of blocks, being guided downward by the guide rails 18 and no longer being supported by the disassembled EPS block 30 there below, then falls into the holding region 64 and is retained by the retaining flanges 74. A spring or other mechanism may be provided to act on each cam 38 to reverse the motion of the upper driver linkages 26 and return the upper handle 20 upwardly back to the original position.

Preferably, the rotational pivot axis 62 of each of the front and rear breaker bars 52, 58 is formed at an offset position on the planar body 67 such that the middle aperture 78 is closer to the top aperture 76 than the retaining flange 74. This arrangement causes the upper portion 68 of the planar body 67 to be smaller than the lower portion 72, and to extend into the holding region 64 upon rotation of the front and rear breaker bars 52, 58 a distance to create the desired amount of compression in upper regions of the pre-cut block 30 and separation in lower regions of the block to compromise the dimensional stability of the block 30 and cause the individual EPS pieces 66 to separate from one another. Additionally, the position of the rotational pivot axis 62 moves each of the retaining flanges 74 sufficiently to allow the separated EPS pieces 66 to substantially free fall unobstructed to the dispensing apparatus 14.

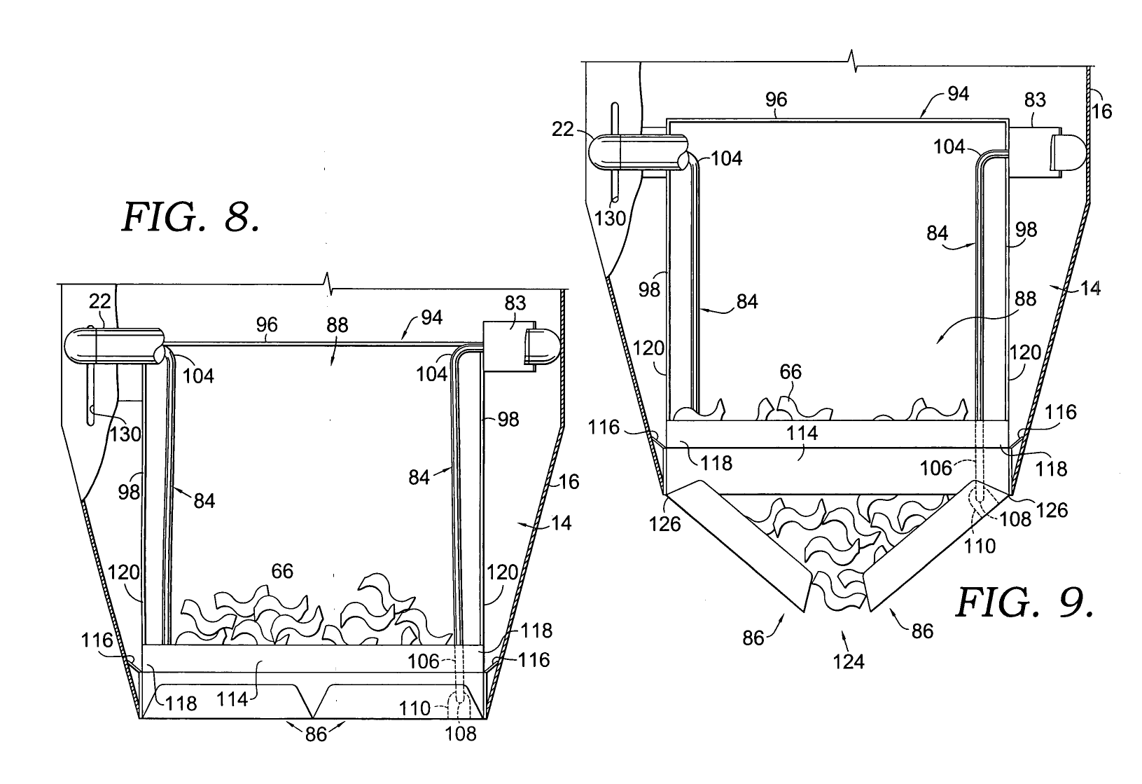

Turning to FIGS. 8-11, and with continued reference to FIG. 2, more detail of the dispensing apparatus 14 is shown. A pair of lower articulating driver linkages 83 are interconnected with one another by the lower handle 22 and are operable to transmit an input force incident upon the lower handle to a pair of control rods 84 that selectively open and close a pair of depending doors 86. These doors 86 combine with the housing 16 of the mechanism 10 in the region of the dispensing apparatus 14 to form a hopper 88 for holding an amount of EPS pieces 66 that result from the disassembly of one or more of the pre-cut EPS blocks 30 by the disassembling apparatus 12.

The lower articulating driver linkages 83 have first ends 90 rigidly interconnected with one another by the lower handle 22 and second ends 92 rotatably mounted with a back stay 94. The back stay 94 has a lateral member 96 to provide stability for the back stay 94 and vertical members 98 rigidly connected with the housing 16 to provide a location for the mounting of the lower driver linkages 83 with the back stay 94. A central portion 100 of each of the lower driver linkages 83 has an aperture 102 to accept an upper end 104 of one control rod 84 therein, and a lower end 106 of each control rod 84 is inserted into an aperture 108 of a rod mount 110 secured with each of the depending doors 86.

A mounting location for the depending doors 86 is provided by a door frame 112 including a front tie 114 spanning laterally across the housing 16 between the doors 86 and a pair of side ties 116 extending rearwardly from opposed ends 118 of the front tie 114 to a rigid connection with a lower portion 120 of the back stay 94. A back tie 122 is also provided and spans laterally across the housing 16 between the vertical members 98 of the backstay 94 to provide structural support to the stay 94. Preferably, the door frame 112 and the back tie 122 are rigidly connected to the housing 16.

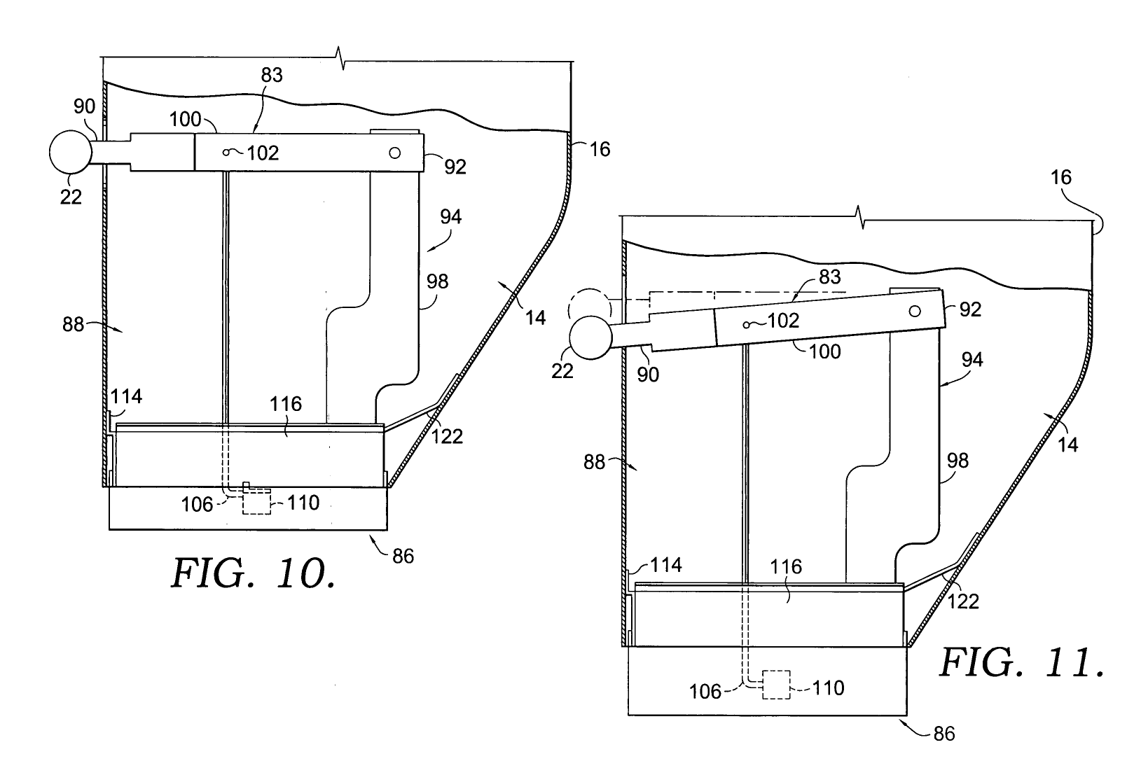

To dispense an amount of EPS pieces 66 through an opening 124 of the hopper 88 regulated by the depending doors 86, the user will pull downwardly on the lower handle 22 from the position depicted in FIGS. 8 and 10. The lower articulating driver linkages 83 rotate downwardly about the mounting position with the back stay 94, and thereby move the control rods 84 downwardly. This motion in turn pushes on the depending doors 86 to rotate the doors 86 downwardly and expose the opening 124. When not acted upon by the control rods 84 the doors 86 may be held in the closed position by, for example, torsion springs (not shown) mounted with a set of pivot points 126 of the doors 86 on the door frame 112. The user can select the degree of downward movement of the lower handle 22 to control the size of the opening 124, as depicted in FIGS. 9 and 11. Once a desired amount of EPS pieces 66 has been dispensed—for example, into a shipping box containing an item to be shipped that is positioned below the opening 124—the user will either pull the lower handle 22 back upwardly to close the doors 86, or simply release the lower handle 22 and allow torsion springs or other means operable with the doors 86 to push the doors 86 back upwardly.

It should be understood that any rigid connections of components of the mechanism 10 may be made by fasteners, welding, or any other means, as those of skill in the art should appreciate. Additionally, the individual components of the dispensing apparatus 14 are preferably formed of metal, plastics, composites or similar materials, and may be fabricated through any number of methods that are well understood by those of skill in the art.

As seen in the overall view of the mechanism 10 illustrated in FIG. 1, the upper handle 20 and the first ends 44 of the input driver bars 36 are exposed to the user through upper slots 128 in the housing 16, and the lower handle 22 and the first ends 90 of the lower driver linkages 83 are likewise exposed to the user through lower slots 130 in the housing 16. A clear window 132 formed into a front side 134 of the housing 16 allows the user to see the accumulation of EPS pieces 66 in the hopper 88.

Thus, as can be seen, the mechanism 10 of the present invention provides a compact and efficient solution for disassembling one or more pre-cut packaging material blocks into a hopper, and selective dispensing of the resulting pieces of packaging material from the hopper as needed by a user. Although reference has been made to a pre-cut block being formed of EPS, such a block could be formed from a variety of other materials used a packaging material or filler, such as other polymers or natural materials (e.g., paper or wood fiber).

Since certain changes may be made in the above invention without departing from the scope hereof, it is intended that all matter contained in the above description or shown in the accompanying drawings be interpreted as illustrative and not in a limiting sense.

1. A mechanism for disassembling a pre-cut block of packaging material into a plurality of component pieces and dispensing the component pieces, comprising:
a housing;
a disassembling apparatus mounted at least substantially within the housing for compressing at least a portion of the pre-cut block of packaging material to cause the pre-cut block of packaging material to separate into the plurality of component pieces; and
a dispensing apparatus mounted at least substantially within the housing for selectively dispensing the plurality of component pieces separated from the pre-cut block.

2. The mechanism of claim 1, the dispensing apparatus including a hopper having a lower section including a set of depending doors selectively moveable between an open position exposing an opening of the hopper to allow the plurality of component pieces to fall out of the hopper, and a closed position retaining the plurality of component pieces within the hopper.

3. The mechanism of claim 2, the hopper further including:
a handle;
a back stay;
at least one lower articulating driver linkage coupled with the handle and pivotably connected with the back stay;
at least one control rod coupled with the at least one lower articulating driver linkage and positioned to actuate the movement of the set of depending doors to at least the open position upon a force being applied to the handle to rotate the at least one lower articulating driver linkage downwardly.

4. The mechanism of claim 3, the at least one lower driver linkage including a pair of driver linkages interconnected by the back stay, the at least one control rod including a pair of control rods, each control rod coupled with one of the pair of lower articulating driver linkages and actuating movement of one of the depending doors, and wherein the hopper further includes a pair of rod mounts each attached to one of the depending doors for coupling the control rod thereto to facilitate movement of the depending doors to the open position when the pair of control rods move downwardly with the rotation of the pair of lower articulating driver linkages downwardly and to the closed position when the pair of control rods move upwardly with the rotation of the pair of lower articulating driver linkages upwardly.

5. The mechanism of claim 1, further including means for guiding a plurality of pre-cut blocks of packaging material into the housing and to the disassembling apparatus in a queue.

6. The mechanism of claim 1, the disassembling apparatus including:
a support frame;
a pair of upper articulating driver linkages operable to transmit an input force; and
a first breaker bar coupled with the pair of upper articulating driver linkages and moveable in response to the transmitted input force, the first breaker bar being guided in movement by the support frame, wherein at least a portion of the pre-cut block of packaging material positioned within a holding region of the disassembling apparatus adjacent to the first breaker bar is compressed by the first breaker bar when the pair of upper articulating driver linkages move in response to the input force to initiate movement of the first breaker bar with respect to the support frame and cause at least a portion of the first breaker bar to move towards the holding region.

7. The mechanism of claim 6, the disassembling apparatus further including:
a second breaker bar coupled with the pair of upper articulating driver linkages and moveable in response to the transmitted input force, the second breaker bar being guided in movement by the support frame and positioned in opposing relation to the first breaker bar, wherein the holding region of the disassembling apparatus is further defined as between the first breaker bar and the second breaker bar, and the at least a portion of the pre-cut block of packaging material is further compressed by the second breaker bar when the pair of upper articulating driver linkages move in response to the input force to initiate movement of the second breaker bar with respect to the support frame and cause at least a portion of the second breaker bar to move towards the holding region.

8. The mechanism of claim 7, the first and second breaker bars each having an upper portion, a middle portion, and a lower portion, the pair of upper articulating driver linkages being pivotably connected with the upper portions of the first and second breaker bars, the first and second breaker bars each being rotatably mounted with the support frame at the middle portions thereof such that the movement of the pair of articulating driver linkages causes the first and second breaker bars to rotate about the middle portion thereof and move the upper portion thereof towards the holding region to compress at least a portion of the pre-cut block of packaging material.

9. The mechanism of claim 7, the first breaker bar and second breaker bar each having a body and a retaining flange extending from the body, the body being coupled with the support frame and the retaining flange supporting the pre-cut block of packaging material during at least a portion of the movement of the first breaker bar and the second breaker bar with respect to the support frame.

10. The mechanism of claim 7, each upper articulating drive linkage of the pair of articulating drive linkages including:
an input driver bar;
an interconnecting member coupled with the input driver bar and rotatable in response to movement of the input driver bar induced by the input force;
a forward output driver bar having a first portion coupled with the interconnecting members and a second portion distal to the first portion and coupled with the first breaker bar, the forward output driver bar being moveable in response to rotation of the interconnecting member and causing the movement of the first breaker bar; and
a rearward output driver bar having a first portion coupled with the interconnecting member at a location spaced from the forward output driver bar and a second portion distal to the first portion and coupled with the second breaker bar, the rearward output driver bar being moveable in response to rotation of the interconnecting member and causing the movement of the first breaker bar.

11. The mechanism of claim 10, the first and second breakers bar each having opposed first and second lateral ends, the forward output driver bar of one articulating drive linkage of the pair of articulating drive linkages being pivotably connected with the first lateral end of the first breaker bar and the forward output driver bar of the other articulating drive linkage of the pair of articulating drive linkages being pivotably connected with the second lateral end of the first breaker bar, and the rearward output driver bar of one articulating drive linkage of the pair of articulating drive linkages being pivotably connected with the first lateral end of the second breaker bar and the rearward output driver bar of the other articulating drive linkage of the pair of articulating drive linkages being pivotably connected with the second lateral end of the second breaker bar, the first and second breaker bars being rotatably mounted at the first and second lateral ends thereof with the support frame.

12. The mechanism of claim 10, each interconnecting member forming a cam and each of the cams being rotatably mounted with the support frame, the input driver bar, the forward output driver bar and the rearward output driver bar of each articulating drive linkage of the pair of articulating drive linkages being pivotably connected with the cam.

13. The mechanism of claim 10, the input driver bars each having opposed first and second ends, the first ends of the input driver bars interconnected with one another by a handle for receiving the force input and the coupling between each input driver bar and the respective interconnecting member being at the second end of each input driver bar of the pair of input driver bars.

14. The mechanism of claim 1, the disassembling apparatus including:
an upper articulating driver linkage adapted to transmit an input force; and
a first breaker bar having a laterally-extending rotational axis and coupled with the upper articulating driver linkage, wherein at least a portion of the pre-cut block of packaging material positioned within a holding region of the disassembling apparatus adjacent to the first breaker bar is compressed by the first breaker bar when the upper articulating driver linkages move in response to the input force to initiate rotation of the first breaker bar about the laterally-extending rotational axis thereof into the holding region.

15. The mechanism of claim 1, the packaging material being expanded polystyrene.

16. A mechanism for disassembling a pre-cut block of packaging material into a plurality of component pieces and dispensing the component pieces, comprising:
a housing;
a disassembling apparatus mounted at least substantially within the housing, the disassembling apparatus including
a support frame having opposed lateral portions,
a pair of upper articulating driver linkages operable to transmit an input force, one of the upper articulating driver linkages disposed adjacent to one of the lateral portions of the support frame, and the other upper articulating driver linkage disposed adjacent to the other lateral portion of the support frame, each upper articulating driver linkage including an input driver bar, an interconnecting member, a forward output driver bar, and a rearward output driver bar, wherein each of the input driver bar and the forward and rearward output driver bars are coupled with the interconnecting member, and wherein the interconnecting member is adapted for rotation in response to the input force transferred thereto by the input driver bar to induce movement of the forward and rearward output driver bars,
a first breaker bar rotatably mounted with the support frame, the first breaker bar being coupled with the forward output driver bars of the pair of articulating driver linkages and rotatable in response to the transmitted input force, and
a second breaker bar rotatably mounted with the support frame, the second breaker bar being coupled with the rearward output driver bars of the pair of articulating driver linkages and rotatable in response to the transmitted input force,
wherein a pre-cut block of packaging material positioned within a holding region of the disassembling apparatus between the first and second breaker bars is compressed by rotation of the first and second breaker bars into the holding region upon receiving the input force from the forward and rearward output driver bars to cause the pre-cut block of packaging material to separate into the plurality of component pieces; and
a dispensing apparatus mounted substantially within the housing for selectively dispensing the plurality of component pieces separated from the pre-cut block.

17. The mechanism of claim 16, the dispensing apparatus including a hopper having a lower section including a set of depending doors selectively moveable between an open position exposing an opening of the hopper to allow the plurality of component pieces to fall out of the hopper, and a closed position retaining the plurality of component pieces within the hopper.

18. The mechanism of claim 17, the hopper further including:
a handle;
a back stay;
at least one lower articulating driver linkage coupled with the handle and pivotably connected with the back stay; and
at least one control rod coupled with the at least one lower articulating driver linkage and positioned to actuate the movement of the set of depending doors to at least the open position upon a force being applied to the handle to rotate the at least one driver linkage downwardly.
